(19) United States
(12) Patent Application Publication
(10) Pub. No.: US 2002/0047265 A1
(43) Pub. Date: Apr. 25, 2002

(54) Manifold

(76) Inventors: Ari Karhu, Mantsala (FI); Esa Hirvonen, Hollola (FI); Jukka Jaakkola, Lahti (FI); Timo Kaplas, Lappeenranta (FI); Juha Hietanen, Heinola (FI); Jarmo Smahl, Nastola (FI)

Correspondence Address: ERIC L. PRAHL, Fish & Richardson P.C., 225 Franklin Street, Boston, MA, 02110-2804, US

(21) Appl. No.: 09/946,766

(22) Filed: Sep. 5, 2001

Related U.S. Application Data
(63) Continuation of application No. PCT/FI00/00235, filed on Mar. 22, 2000.

(30) Foreign Application Priority Data
Mar. 22, 1999 (FI) 990638

(51) Int. Cl. F16L 39/00; F16L 41/00

(52) U.S. Cl. 285/125.1; 285/423; 285/354

(57) ABSTRACT

A manifold, which comprises a body (2) with pipe fittings (3). The body (2) is at least mainly made of plastic material. The body (2) is formed such that it comprises ribs (5), which are most preferably arranged in the peripheral direction of the body.

The invention relates to a manifold, which comprises a body with pipe fittings and which body is at least mainly made of plastic.

Manifolds can either be made of metal or plastic. Metal manifolds are difficult to manufacture, expensive and heavy. Walls of plastic manifold bodies must be made fairly thick, and thus a lot of material is used for their manufacture. In addition, it is fairly difficult to form tight connections in the extension devices of plastic manifolds.

The object of the present invention is to provide a manifold, by which at least some of the above drawbacks can be avoided.

The manifold of the invention is characterized in that the body is formed such that it comprises ribs.

The essential idea of the invention is that the manifold body is at least mainly made of plastic material and that the body is ribbed. According to the idea of a preferred embodiment, the ribbing of the manifold body is arranged in the peripheral direction of the body. The idea of a second preferred embodiment is that the manifold is mainly made of polysulphone. The idea of a third preferred embodiment is that pipes are arranged to be connected to the manifold by means of a ribbed plastic sleeve.

An advantage of the invention is that the ribbing improves the strength and stiffness of the manifold and provides protection against impacts. Further, the thickness of the body wall need not be so great as in a plastic manifold without ribs, and thus the ribbing saves material. When the wall is thinner, the material in the mould cools faster and on the other hand, the ribbing also increases the cooling area of the mould and thus accelerates the cooling, wherefore the manufacture of the manifold is faster, since less material is needed and the cooling is faster. The ribbing in the peripheral direction of the body is particularly favourable to the strength and stiffness. Manifolds made of polysulphone also withstand high temperatures very well. A ribbed plastic sleeve is simple and cheap to manufacture and the sleeve ribbing also saves material, provides a better strength, a better dimensional stability and a faster manufacture. Further, it is easy to get hold of the ribbed sleeve to turn it and the ribbing hinders the principal wall of the sleeve from being damaged by possible tools.

The invention is described in greater detail in the attached drawing, in which

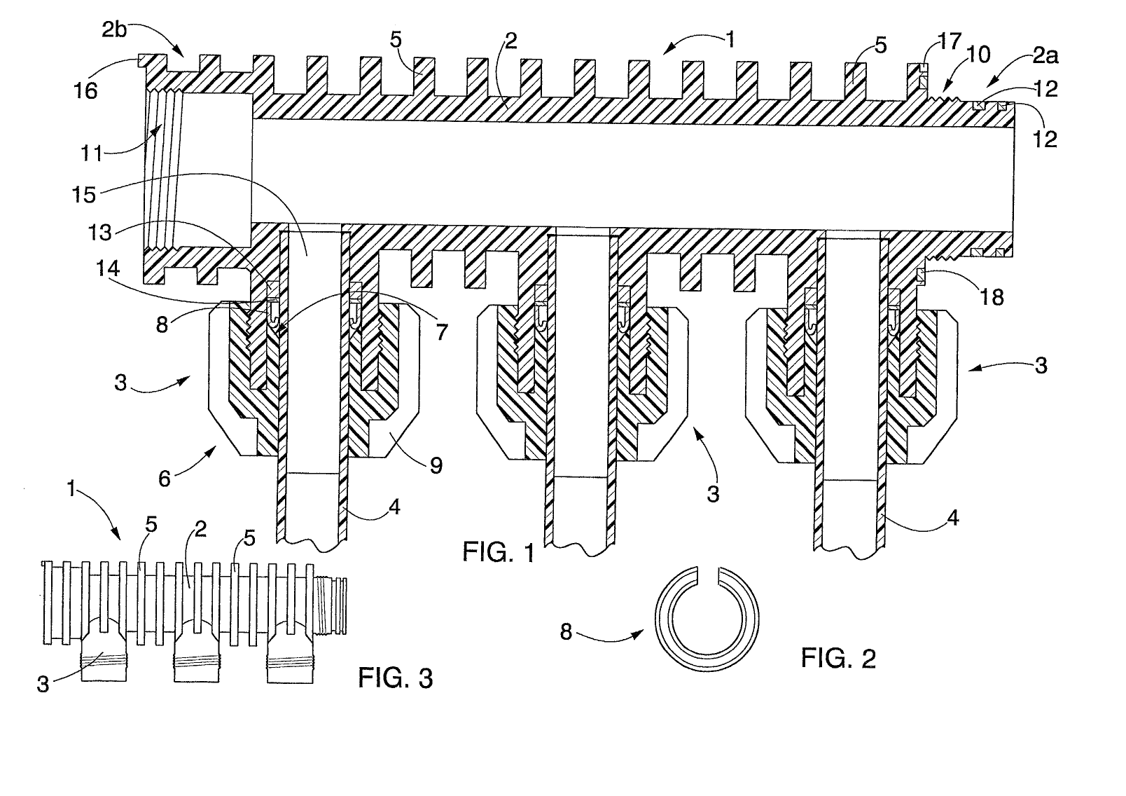

FIG. 1 shows a schematic cross-sectional view of a manifold according to the invention,

FIG. 2 shows schematically a tightening washer to be used in connection with a joint of the manifold according to FIG. 1, and

FIG. 3 shows a side view of the manifold according to FIG. 1.

FIG. 1 shows a manifold 1. The manifold 1 comprises a body 2 with pipe fittings 3, to which branch pipes 4 to be connected are joined. The main pipe can be attached to a first end 2a of the body or to a second end 2b of the body. Further, extension devices of the manifold can be attached to the first end 2a of the body and to the second end 2b of the body. The manifold 1 is adapted to a pressure pipe use, i.e. the manifold body 2 and the pipe fittings 3 and the connections joined to them must resist the pressure of the fluid inside the manifold 1, the pressure being typically 5 to 6 bar. The manifold 1 is most preferably dimensioned to resist the pressure of 10 bar. The function of the manifold 1 is to distribute the fluid passing through it to several branch pipes 4 connected to it.

The material of the body 2 is at least mainly plastic, and thus the manifold 1 can be manufactured by injection moulding, for example, and therefore the manufacture of the manifold 1 is fast and easy and the price of the manifold 1 will not be high. Most preferably the material of the manifold 1 is polysulphone which has a sufficient resistance to high temperatures of hot water flowing inside the manifold 1, for example. The manifold can also be made of cross-linked polyethylene, i.e. PEX. If the manifold is not used in a hot-water system, it can also be made of polypropylene PP, for instance. A cold-water manifold in turn can be made of high density polyethylene HDPE, for example. If a manifold is used for example in a system in which the fluid is oil or petrol or the like, the manifold can also be made of polyamide PA, for instance. The body 2 is provided with ribs 5, which improve the strength and stiffness of the manifold body 2 and provide protection against impacts. Due to the ribs 5, the thickness of the principal wall of the body 2 can be fairly thin, and the manufacture of the manifold 1 does not require a considerable amount of material. Because of the thinness of the principal wall, the material injected into a mould cools fairly fast. Further, due to the ribs 5 the cooling area of the mould is quite big. Thus, due to the fairly small amount of material and the efficient cooling, the cycle time of injection moulding can be arranged to be quite short, wherefore the manufacture of the manifold 1 is quite fast. Thus, the object of the ribbing is partly that the surface area of the manifold 1 increases proportionally faster than its weight, due to the supplementation of the ribs 5. For example, the mass of a conventional smooth four-branch manifold was 115 g and the outer surface area was 26000 mm². This manifold was altered such that ribs 5 were formed thereto, the ribs supporting pipe fittings 3. In addition to this, the manifold was provided with a fixing mechanism based on flanging. The mass of the manifold increased 1.32-fold and the outer surface area increased 1.62-fold. In addition, impact strength and torsional stiffness in the raised temperature multiplied. Most preferably, when a manifold 1 is thus provided with ribs 5, its outer surface area increases over 10% more than what its weight increases, when compared to a smooth manifold. Most preferably the ribs 5 are arranged in the peripheral direction of the body 2, as shown in FIG. 1, whereby the strengthening and stiffening effect of the ribs 5 are most effective. Most preferably the height of the rib 5, i.e. the distance of its upper surface from the outer body 2 surface is at least equally great as the thickness of the body 2 wall.

Manifolds are dimensioned in their wall strength equally as the corresponding pipes and pipe branches. If the strength of plastic, i.e. tensile strength, with a 0.2% strain is great and the creep in a long-term test is small, the dimensioning stress allowable for plastic, when divided by a constant safety factor, is fairly high, which is preferable because of the low consumption of the material. On the other hand, there are also other considerable forces that direct to the manifold with branches than only those caused by the internal pressure of the pipe. These other loads may be caused by heat expansion of pipes, for example. The heat expansion of a long pipe may direct to one point. Shear stresses in manifolds, too, can become very high due to the heat expansion or load peaks during the installation.

Thus, it can be noted that the dimensioning of the manifold only according to the allowable ring stiffness in the peripheral direction is not always reasonable. When using strong plastic, the manifold can have so thin walls that a buckling or some other loss of stability becomes the crucial factor in the dimensioning. It is especially difficult to dimension a manifold in the case where it deals with a manifold intended for a hot-water use. The dimensioning stress of plastic is firmly tied to the operating temperature. For example, the dimensioning stress of high density polyethylene HDPE decreases to a third when the temperature rises from 20° to 45°. Therefore, it would be preferable to keep certain structural parts as cool as possible. Although a radial rib strengthening is not in its efficiency a very efficient strengthening method in case of the load being caused by internal pressure, it is a very efficient method in the case of a manifold, when the load tends to bend the branch. A special advantage of using ribs 5 is that due to the large outer surface area of the manifold 1 the temperature of the manifold material can be made lower than what would be the temperature of the material of a tubular manifold 1. Thus, in connection with a hot-water manifold the ribs 5 function as cooling ribs cooling the manifold 1.

The branch pipes 4 to be connected are joined to the pipe fittings 3 of the manifold 1 by means of sleeves 6. A cone surface 7 is arranged to the sleeves 6 and a metal tightening washer 8, for example, is arranged around the pipe 4 to be connected. There are threads on the inner surface of the sleeve 6, the threads fitting to the threads of the outer surface of the pipe fitting 3. By turning the sleeve 6, the cone surface 7 can be pushed against the tightening washer 8, whereby the cone surface 7 presses the tightening washer 8 against the pipe 4 to be connected and the connection can be made tight. Along its circumference, the tightening washer 8 is not of equal size, but it is provided with a slit, which enables the reduction in the size of the circumference of the tightening washer 8 when it presses against the tube 4. FIG. 2 shows a schematic top view of the tightening washer 8. A plate-like sealing 13 is also arranged around the tube 4, and when the sleeve 6 is tightened, the sealing alters its shape so that it shortens a bit in the axial direction, wherefore it is pressed very closely against the tube 4 in the radial direction. A washer 14 is arranged between the tightening washer 8 and the sealing 13, the function of which washer is to support and protect the sealing 13 when the sleeve is tightened such that the tightening washer 8 does not penetrate into the sealing 13 or harm it in some other way. The washer 14 and the tightening washer 8 can be made of stainless steel, for example.

The connection structure can also be assembled in the factory in advance such that the sealing 13, the washer 14 and the tightening washer 8 are installed into the fitting 3 by means of the sleeve 6. No separate tools are needed for the installation at a working site, but the tube 4 can be pushed into the fitting 3 without even taking off the sleeve 6. If the wall of the tube 4 is not strong enough, an insert section 15 made of stainless steel, for example, can be arranged inside it to improve stiffness.

The sleeve 6 is provided with ribs 9, by which a better strength, stiffness and dimensional stability as well as material savings and manufacturing savings can be achieved in the same way as when a ribbed manifold 1 is manufactured. The ribs 9 can be in the axial direction, as shown in FIG. 1, in which case it is easy to get hold of the sleeve 6 in order to turn it. The ribs 9 may also be arranged in the peripheral direction of the sleeve 6, in which case they improve the stiffness of the sleeve 6 efficiently.

When the axial ribbing is used, it is easy to form a controlled breaking point to them. The ribs are in this case formed such that when the sleeve 6 is tightened, the first ones to give way are the ribs 9. Thus, the threads of the sleeve remain intact and overtightening can be avoided. Thus, the sleeve 6 can be easily dimensioned such that its tensile strength in the peripheral direction is poorer than the compression strength of the body of the fitting 3 inside the sleeve 6.

The sleeves 6 can also be made of polysulphone, for instance. On the other hand, the sleeve 6 material need not be in touch with the fluid, e.g. water, flowing in the manifold 1 and the pipe 4, whereby the material of the sleeve 6 can also be a cheaper material than polysulphone, e.g. polyamide PA can be used. A particularly preferable combination is such that the manifold 1 is made of polysulphone and the sleeve 6 is made of polyamide, which combination can also be used in hot-water systems, but the sleeve 6 material is, however, rather cheap. Other possible plastic materials for manufacturing a sleeve 6 are e.g. cross-linked polyethylene PEX, polypropylene PP and high density polyethylene HDPE.

Threads 10 are arranged on the outer surface of the first end 2a of the manifold 1 body, by which threads an extension device can be attached to the manifold 1. Sealings 12 are arranged between the threads 10 and the manifold 1 end, whereby the fluid inside the manifold cannot act on the threads. In addition to or instead of the outer surface of the first end 2a, the sealings 12 can also be placed inside the second end 2b of the manifold 1 body. The sealings 12 form an axial sealing surface. Further, a sealing 18 can be arranged to the front surface of either the first end 2a or the second end 2b of the manifold 1 body or on both front surfaces, whereby a sealing surface in the peripheral direction can be formed. Thus, there is both an axial and a peripheral sealing surface between the manifolds 1 connected to each other.

As sealing 12, 13 and 18 material, ethylene/propylene/diene rubber EPDM, silicone rubber, nitrile-rubber or polytetrafluoroethylene PTFE, for instance, can be used. The sealings 12 and 13 can also be made of some other rubber or a composition of plastic and rubber or plastic.

Either the axial sealing surface or the peripheral sealing surface can also be provided at the factory with a layer reacting easily to heat such that as a result, a very tight connection is achieved. On the other hand, the sealing 12 or 18 can be a sealing made of a polymer, which, due to the heat, provides a sealing. Thus, long entities can be assembled from the manifolds 1 at the factory, the connections of which entities are very tight, since the sealings need not depend on rubber-ring sealings only.

Correspondingly, there are threads 11 inside the second end 2b of the manifold 1 body, and therefore two manifolds 1 according to FIG. 1, for example, can be firmly attached to each other by means of the threads 10 and 11, and thus an entity of a desired size can easily be assembled from the manifolds 1. A pin 16 can be arranged to the second end 2b of the manifold 1 body, and a corresponding cavity 17 can be arranged to the vicinity of the first end 2a of the manifold 1 body, e.g. to the rib 5, in which case, when two corresponding manifolds 1 are twisted together, they can be locked at the same positions by means of the pin 16 and the cavity 17. Different manifolds 1 can also be attached to each other by means of a bayonet connection formed at their ends. Then the ribs 5 can be utilized as parts of the bayonet connection.

FIG. 3 shows a side view of the manifold 1. For the sake of clarity, FIG. 3 does not show the pipes 4 to be connected and the sleeves 6. The ribs 5 located at the pipe fittings 3 are fixedly arranged to the pipe fittings 3. Thus, the majority of the ribs 5 supporting the body 2 also support the pipe fitting 3.

The drawing and the related description are only intended to illustrate the idea of the invention. In its details the invention may vary within the scope of the claims. Consequently, the number of pipe fittings 3 of a manifold 1 can vary, when required. Further, the manifold of the invention can be used for example as a hot-water manifold, warm-water manifold, cold-water manifold or as a manifold in an apparatus, in which some other fluid, such as oil or petrol, is used. Instead of injection moulding, a manifold 1 can also be manufactured by extruding, for example. A tube clip, for example, can be installed on top of the ribs 5, for example, which clip can be tightened to the ribs 5 very firmly. Even though the tube clip is tightened, it does not increase the tensions directing to the body 2 itself. The ribs 5 need not necessarily be arranged to surround the whole manifold 1 body 2, but the ribs 5 can be arranged, for example, mainly around the pipe fittings 3 only. The rib 5 need not be round in the axial direction of the manifold 1, but it can also be angular. For example, if the ribs 5 are quadrangular, a manifold 1 is created, which, when placed against the wall, for example, stays very firmly in place without turning. The ribbing can also be provided with a locking profile, from which the manifold 1 can be pushed for example to an aluminium locking rail with such a profile that the manifold and the rail are locked into each other. The manifold ribs 5 can also be shaped as a handle, from which the manifold 1 can be hung to a rack, for example.

1. A manifold, which comprises a body with pipe fittings the body being at least mainly made of plastic, and being formed such that it comprises ribs.

2. A manifold as claimed in claim 1, wherein the ribs are arranged at least mainly in the peripheral direction of the body.

3. A manifold as claimed in claim 1, wherein the body is at least mainly made of polysulphone.

4. A manifold as claimed in claim 1, wherein the manifold is adapted to a pressure pipe use.

5. A manifold as claimed in claim 1, wherein the height of the rib is at least equally great as the thickness of the body wall.

6. A manifold as claimed in claim 1, wherein at least some of the ribs are arranged to support the pipe fittings.

7. A manifold as claimed in claim 1, wherein due to the effect of the ribs provided at the manifold, its outer surface area has increased over 10% more than how much its weight has increased, due to the supplementation of the ribs.

8. A manifold as claimed in claim 1, wherein branch pipes are arranged to be connected to the pipe fittings of the manifold by means of a sleeve that is at least mainly made of plastic material.

9. A manifold as claimed in claim 8, wherein the manifold body is at least mainly made of polysulphone and that the sleeve is at least mainly made of polyamide.

10. A manifold as claimed in claim 8, wherein the sleeve is formed such that it comprises ribs.

11. A manifold as claimed in claim 8, wherein the tensile strength in the peripheral direction of the sleeve is poorer than the compression strength of the body of the pipe fitting.

12. A manifold as claimed in claim 1, wherein the body comprises a first end and a second end, whereby the first end of the body and the second end of the body are provided with connection means such that another corresponding manifold is attachable to the end of the manifold by means of the connection means.

13. A manifold as claimed in claim 12, wherein threads function as the connection means for connecting the manifolds to each other.

14. A manifold as claimed in claim 12, wherein there is an axial sealing surface and a peripheral sealing surface at the first end or the second end of the manifold body, or at both ends.
